(19) United States
(12) Patent Application Publication
(10) Pub. No.: US 2008/0301565 A1
(43) Pub. Date: Dec. 4, 2008

(54) Bookmarking and lassoing in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/809,736

(22) Filed: Jun. 1, 2007

(51) Int. Cl. G06F 3/00

(52) U.S. Cl. 715/744

(57) ABSTRACT

A method, apparatus and system of bookmarking and lassoing in a geo-spatial environment are disclosed. In one embodiment a method of bookmarking a plurality of entries includes receiving a lasso drawn on a geo-spatial map by a user, obtaining a region on the geo-spatial map based on the lasso, obtaining the plurality of entries from within the region, creating a plurality of bookmarks corresponding to the plurality of entries, associating the plurality of bookmarks with the user, and enabling access to the plurality of entries by the user using the plurality of bookmarks. The method may further include associating the plurality of entries with a group. The method may also include providing additional information corresponding to the plurality of entries to the user. The method may include presenting a mass profile edit option to the user for the plurality of entries.

### FIELD OF TECHNOLOGY

This disclosure relates generally to the technical fields of communications and, in one example embodiment, to a method, apparatus, and system of bookmarking and lassoing in a geo-spatial environment

### BACKGROUND

Computer bookmarks are used to catalog and access web pages, documents, music, video, and/or other digital media with ease. Bookmarks may be represented as pointers to the media that are catalogued. For example, a website may be bookmarked using a Uniform Resource Locator (URL) of the website and/or a name for the website; the name may be taken from contents of a Hyper Text Markup Language (HTML) tag within the website, such as a title tag, or the name may be provided by a user bookmarking the website. Bookmarking utilities are often provided by web browsers for users to access sites without having to remember the URLs or rely on other computer programs. The bookmarks may also be saved on a web server for access from multiple locations.

In addition to personal bookmarks (e.g., stored by a web browser), the bookmarks may be shared among multiple users. Social bookmarking refers to a web-based service for storing, classifying, sharing, and/or searching Internet links. The bookmarks may be accessible to public and/or to a specific network based on a privacy level for each bookmark. The bookmarks may also be associated with one or more tags and/or categories to classify and/or group the bookmarks. Consequently, users with similar interests may view the bookmarks by the category, by searching for one or more tags associated with the bookmarks, or by random.

Social bookmarking services have also extended the categorization of bookmarks by implementing algorithms to draw inferences from keywords and/or tags that are assigned to bookmarks by examining clustering of particular keywords and relation of the keywords to one another. In addition, the social bookmarking services have enabled user rating, commenting, import and export of bookmarks, addition of notes and/or email links, automatic notification, feed subscription, web annotation, and/or creation of groups and community networks around the bookmarks.

Internet and social bookmarking may be currently limited to sharing of web links. In addition, bookmarks are normally found, tagged, and/or grouped independently of one another. As a result, creating categories and/or groups around bookmarks may be slow, tedious, and/or limited to certain Internet resources such as URLs.

### SUMMARY

A method, apparatus and system of bookmarking and lassoing in a geo-spatial environment are disclosed. In one aspect, a method of bookmarking a plurality of entries (e.g., may be selected from a group consisting of persons, businesses, organizations, and/or landmarks) includes receiving a lasso drawn on a geo-spatial map by a user, obtaining a region on the geo-spatial map based on the lasso, obtaining the plurality of entries from within the region, creating a plurality of bookmarks corresponding to the plurality of entries, associating the plurality of bookmarks with the user, and enabling access to the plurality of entries by the user using the plurality of bookmarks.

The method may further include associating the plurality of entries with a group. The method may include providing additional information (e.g., may be selected from a group consisting of sale, event, neighbor, travel option, and/or lodging option) corresponding to the plurality of entries to the user. The method may include presenting a mass profile edit option associated with the plurality of entries to the user. The method may include presenting a profile analytic associated with the plurality of entries to the user.

In another aspect, a community network includes a geo-spatial repository containing a plurality of locations on a geo-spatial map, and a group management module configured to receive a lasso drawn on the geo-spatial map by a user, obtain a region (e.g., may include a plurality of entries) on the geo-spatial map based on the lasso, create a group corresponding to the plurality of entries (e.g., may be selected from group consisting of person, business, organization, and landmark), and associate the plurality of entries with the group.

The community network may further include a bookmark management module configured to create a plurality of bookmarks corresponding to the plurality of entries, associate the plurality of bookmarks with the user, and enable access to the plurality of entries by the user using the plurality of bookmarks.

The community network may include a member repository containing a plurality of members (e.g., may include the user), and a member management module configured to obtain member data (e.g., may include a location) associated with each of the plurality of members. The community network may include the bookmark management module further configured to provide additional information (e.g., may be selected from a group consisting of sale, event, neighbor, travel option, and/or lodging option) corresponding to the plurality of entries to the user.

In yet another aspect, a method of creating a group in a community network includes receiving a lasso drawn on a geo-spatial map by a user, obtaining a region on the geo-spatial map based on the lasso, obtaining a plurality of entries (e.g., may be selected from a group consisting of person, business, organization, and landmark) from within the region, obtaining a group name from the user, creating a group under the group name, and associating the plurality of entries with the group.

The method may further include creating a plurality of bookmarks corresponding to the plurality of entries, associating the plurality of bookmarks with the user, and enabling access to the plurality of entries by the user using the plurality of bookmarks. The method may include providing additional information (e.g., may be selected from a group consisting of sale, event, neighbor, travel option, and/or lodging option.) corresponding to the plurality of entries to the user. The method may include presenting a mass profile edit option associated with the plurality of entries to the user. In addition, the method may include presenting a profile analytic associated with the plurality of entries to the user.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of members of a community communicating with each other through a community network, according to one embodiment.

FIG. 2A is a user interface view of creating bookmarks corresponding to entries obtained in a neighborhood, according to one embodiment.

FIG. 2B is a user interface view of creating a group corresponding to the entries in the neighborhood, according to one embodiment.

FIG. 3 is a user interface view of a homepage of a user, according to one embodiment.

FIG. 4 is a user interface view displaying bookmarks associated with the places, according to one embodiment.

FIG. 5 is a user interface view displaying bookmarks associated with businesses, according to one embodiment.

FIG. 6 is a user interface view displaying bookmarks associated with neighbors in the neighborhood, according to one embodiment.

FIG. 7 is a user interface view displaying entries associated with a particular group, according to one embodiment.

FIG. 8 is a flow chart of geo-spatial bookmark creation, according to one embodiment.

FIG. 9 is a diagrammatic system view of a data processing system in which any of the embodiments disclosed herein may be performed, according to one embodiment.

FIG. 10A is a process flow of bookmarking the entries, according to one embodiment.

FIG. 10B is a continuation of the process flow of FIG. 10A, showing additional processes, according to one embodiment.

FIG. 11A is a process flow of creating a group in the community network, according to one embodiment.

FIG. 11B is a continuation of the process flow of FIG. 11A, showing additional processes, according to one embodiment.

Other features of the present embodiments will be apparent from the accompanying drawings and from the detailed description that follows.

### DETAILED DESCRIPTION

A method, apparatus and system of bookmarking and lassoing in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

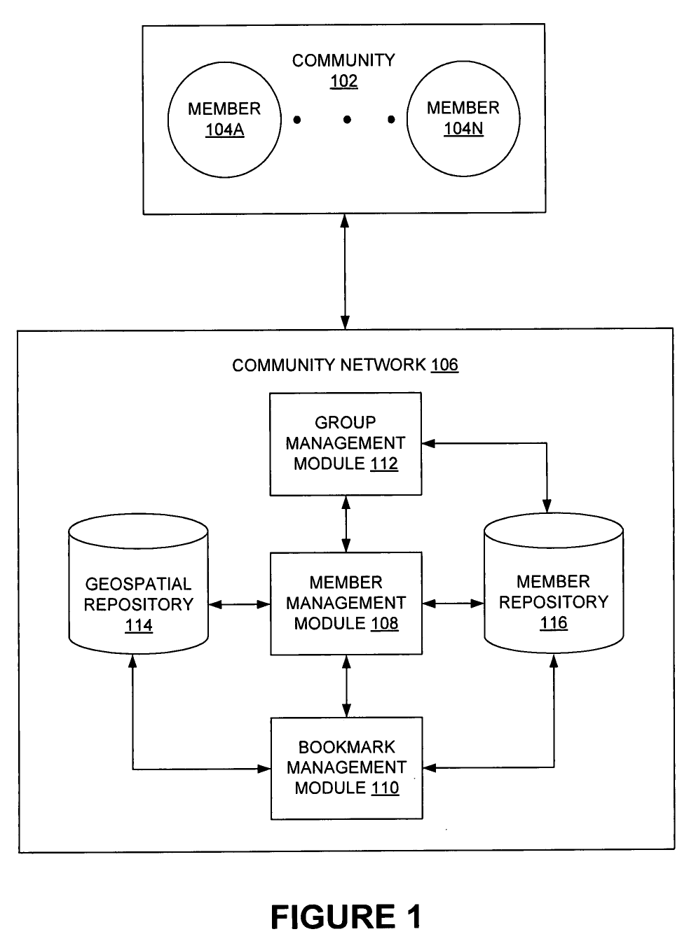

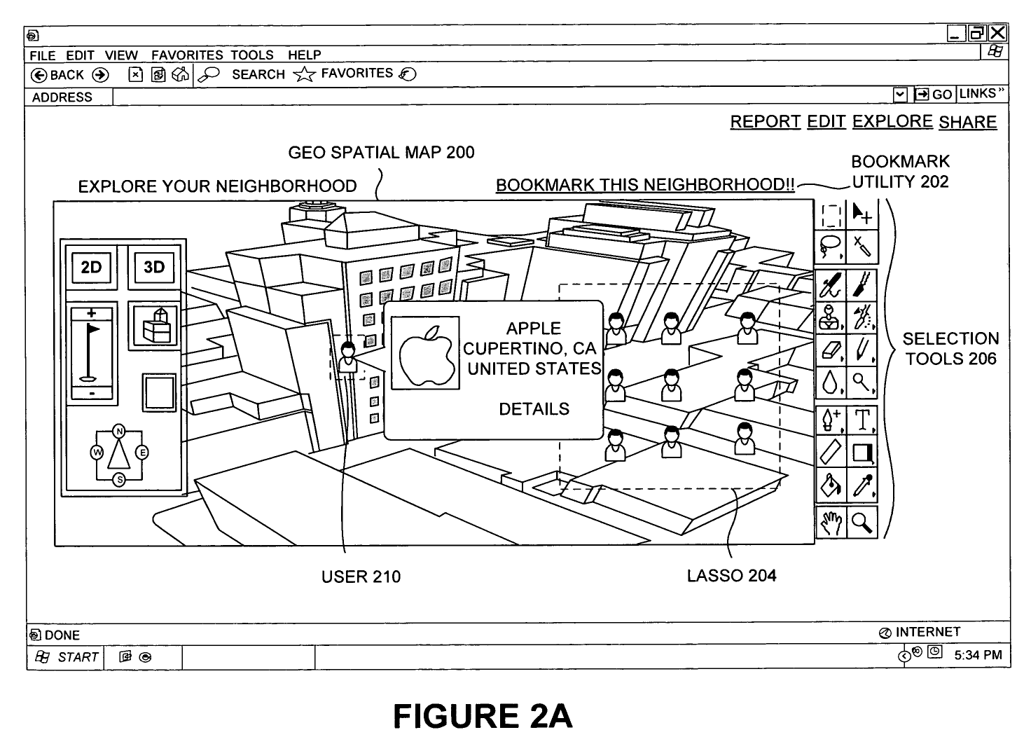

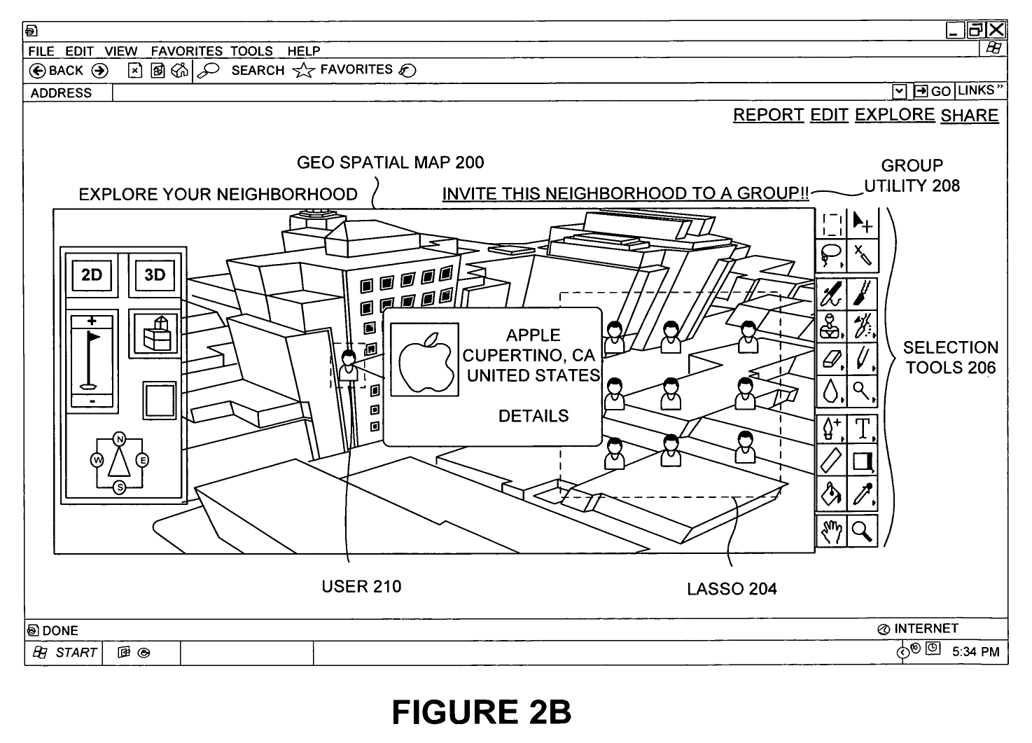

In one embodiment, a method of bookmarking any number of entries includes receiving a lasso (e.g., the lasso 204 of FIG. 2A-B) drawn on a geo-spatial map (e.g., the geo-spatial map 200 of FIG. 2A-B) by a user (e.g., the user 210 of FIG. 2A-B), obtaining a region on the geo-spatial map 200 based on the lasso 204, obtaining the entries from within the region, creating any number of bookmarks (e.g., using the bookmark management module 110 of FIG. 1) corresponding to the entries, associating the bookmarks with the user 210, and enabling access to the entries by the user 210 using the bookmarks.

In another embodiment, a community network (e.g., the community network 106 of FIG. 1) includes a geo-spatial repository (e.g., the geo-spatial repository 114 of FIG. 1) containing a number of locations on a geo-spatial map (e.g., the geo-spatial map 200 of FIG. 2A-B), and a group management module (e.g., the group management module 112 of FIG. 1) configured to receive a lasso (e.g., the lasso 204 of FIG. 2A-B) drawn on the geo-spatial map 200 by a user 210, obtain a region (e.g., may include any number of entries) on the geo-spatial map 200 based on the lasso 204, create a group corresponding to the entries, and associate the number of entries with the group.

In yet another embodiment, a method of creating a group in a community network 106 includes receiving a lasso (e.g., the lasso 204 of FIG. 2A-B) drawn on a geo-spatial map (e.g., the geo-spatial map 200 of FIG. 2A-B) by a user 210, obtaining a region on the geo-spatial map 200 based on the lasso 204, obtaining any number of entries from within the region, obtaining a group name from the user 210, creating a group (e.g., using the group management module 112 of FIG. 1) under the group name, and associating the entries with the group.

FIG. 1 is a system view of members 104A-N of a community 102 communicating with each other through a community network 106, according to one embodiment. Particularly, FIG. 1 illustrates the community 102, the members 104A-N, the community network 106, a member management module 108, a bookmark management module 110, a group management module 112, a geo-spatial repository 114, and a member repository 116, according to one embodiment.

The community 102 may refer to a group of members 104A-N residing in a specific region. The members 104A-N may include persons, businesses, organizations and/or landmarks associated with specific geographic locations in the community 102. In an alternate embodiment, the members 104A-N may reside in multiple regions (e.g., multiple cities, states, countries, etc.). The members 104A-N may be connected through the community network 106. The community network 106 may be a network formed by association of the members 104A-N having user profiles in the community 102. The member management module 108 may obtain member data associated with the members 104A-N. For example, the member data may include a name, an age, a profession, and/or an address data associated with the members 104A-N of the community 102. The member data may be displayed in profiles of the members 104A-N. In addition, the profiles of the members 104A-N may be editable by other members.

In one example embodiment, the member management module 108 displays a profile analytic to a user scrolling over a profile. For example, the profile analytic may contain information of the members 104A-N who edited a profile, who appended content to the profile, a level of completeness of the profile, a number of users (e.g., the members 104A-N) that have viewed the profile, etc. In addition, the profile analytic may provide a set of statistics associated with the profile without displaying an actual profile to the user 210.

The bookmark management module 110 may create bookmarks corresponding to entries obtained from a specified region in a lasso (e.g., the lasso 204 of FIG. 2A-B) drawn by the user 210. In addition, the bookmark management module 110 may enable the user 210 to access the entries using the bookmarks. For example, the user 210 may access the entries to view, update and/or modify the information associated with the entries obtained from the specified region. The bookmark may be a process to store the entries obtained from the specific region into a specific category (e.g., my places 304, my businesses 306, my neighbors 308, etc.) so that the user 210 can access the entries in the future. For example, the bookmark may be a pointer to an entry. The pointer may be represented as a memory address, Hyper Text Transfer Protocol (HTTP), Uniform Resource Locator (URL), Internet Protocol (IP) address, etc.

The bookmark management module 110 may also provide additional information associated with a sale, an event, a neighbor, a travel option, and/or a lodging option to the user 210. For example, the user 210 may click on a bookmark saved in the bookmark management module 110. The bookmark management module 110 may display the bookmarked location to the user 210 on a geo-spatial map (e.g., the geo-spatial map 200 of FIG. 2A-B). In addition, the bookmark management module 110 may provide additional information related to the bookmarked location, such as neighbors residing near the bookmarked location, sales near the bookmarked location, events occurring in the vicinity of the bookmarked location, driving directions to the bookmarked location, airfare options to the bookmarked location, lodging options near the bookmarked location, etc.

The group management module 112 may obtain a region on a geo-spatial map 200 corresponding to the lasso 204 drawn on the geo-spatial map 200 by the user 210. The group management module 112 may further create groups having similar interests (e.g., pet lovers group, friends group, neighbors group, etc.) around the bookmarks corresponding to the entries. For example, the entries having interest in music may be stored in a music group created by the user 210 in groups buddy list. In another example, a high school or college group may be created by drawing a lasso 204 around neighborhoods encompassing the high school or college. The geo-spatial repository 114 may be a database containing location information associated with the members 104A-N of the community 102 on the geo-spatial map 200. The member repository 116 may be a database containing the member data associated with the members 104A-N. In one example embodiment, groups may be created with any number of members 104A-N in the member repository 116.

In the example embodiment illustrated in FIG. 1, the members 104A-N of the community 102 communicate with each other through the community network 106. The members 104A-N may communicate with each other using a variety of methods, such as mail, email, text messaging, instant messaging, telephone, etc. The community network 106 includes the member management module 108, the bookmark management module 110, the group management module 112, the geo-spatial repository 114, and the member repository 116, according to one embodiment.

A lasso 204 drawn (e.g., using the selection tools 206 of FIG. 2A-B) on a geo-spatial map (e.g., the geo-spatial map 200 of FIG. 2A-B) by a user (e.g., the user 210 of FIG. 2A-B) may be received. In one example embodiment, the lasso 204 may be generated by obtaining a polygon drawn by the user 210. The polygon may be specified by clicking on points in the geo-spatial map 200. For example, other shapes, such as circles, squares, triangles, rectangles, etc. may also be drawn using the selection tools 206.

A region may be obtained on the geo-spatial map 200 based on the lasso 204 (i.e., the shape drawn by the user 210). A number of entries (e.g., person, business, organization and/or landmark) from within the region may be obtained (e.g., using the member management module 108 of FIG. 1). For example, entries with locations corresponding to the selected region may be retrieved from one or more repositories. A number of bookmarks corresponding to the entries may be created (e.g., using the bookmark management module 110 of FIG. 1) and/or may be associated with the user 210. The user 210 may be enabled to access the entries using the bookmarks.

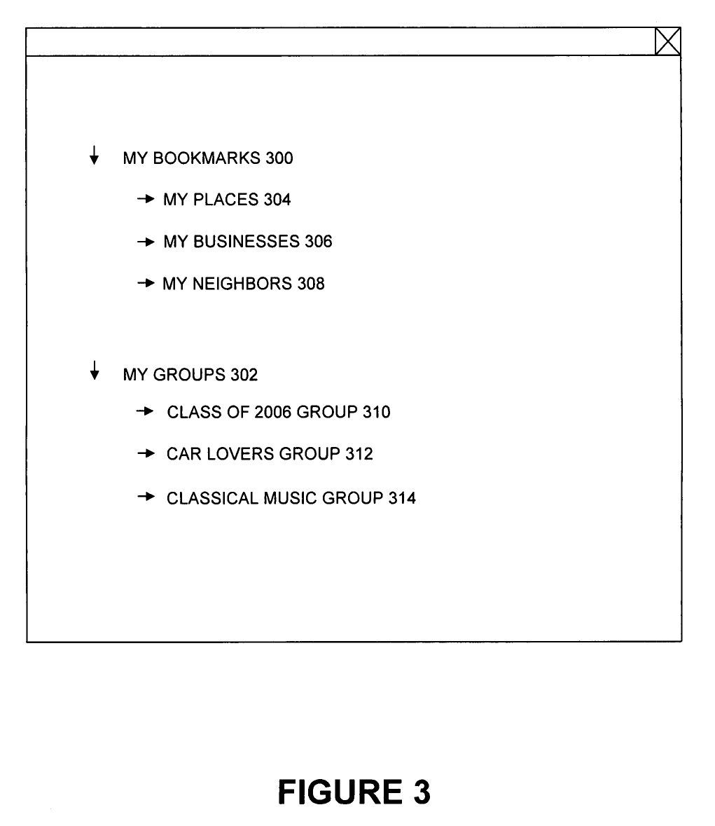

The entries may be associated (e.g., using the group management module 112 of FIG. 1) with a group (e.g., class of 2006 group option 310, car lovers group option 312, and/or classical music group option 314 of FIG. 3). Additional information (e.g., sale, event, neighbor, travel option, and/or lodging option) corresponding to the entries may be provided to the user 210. A mass profile edit option associated with the entries may be presented to the user 210. The profile analytic associated with the entries may be presented to the user 210.

The geo-spatial repository 114 may include any number of locations on the geo-spatial map 200. For example, the geo-spatial repository 114 may include locations within a certain region, such as a city, state, country, continent, etc. The group management module 112 may be configured to receive the lasso 204 drawn on the geo-spatial map 200 by the user 210. In addition, the group management module 112 may obtain the region (e.g., the region may include any number of entries) on the geo-spatial map 200 based on the lasso 204. In addition, the group management module 112 may create the group corresponding to the entries (e.g., person, business, organization, and/or landmark) and/or may associate the entries with the group.

The bookmark management module 110 may be configured to create the bookmarks corresponding to the entries. In addition, the bookmark management module 110 may associate the bookmarks with the user 210. In addition, the bookmark management module 110 may enable the user 210 to access the entries using the bookmarks.

The member repository 116 may include any number of members 104A-N (e.g., members 104A-N may include the user 210). The member management module 108 may be configured to obtain member data (e.g., may include a location) associated with each of the members 104A-N. For example, the member management module 108 may send a list of members 104A-N in the member repository 116 corresponding to a region received by the group management module 112. In addition, the member management module 108 may cross-reference members in the member repository 116 with locations in the geo-spatial repository 114 to determine the members 104A-N that correspond to the region. The bookmark management module 110 may further be configured to provide additional information (e.g., sale, event, travel option, and/or lodging option) corresponding to the entries to the user 210.

FIG. 2A is a user interface view of creating bookmarks corresponding to the entries, according to one embodiment. Particularly, FIG. 2A illustrates a geo-spatial map 200, a bookmark utility 202, a lasso 204, and selection tools 206, according to one embodiment.

The geo-spatial map 200 may graphically display the lasso 204 drawn by the user 210 corresponding to the region in a geo-spatial environment. The bookmark utility 202 may create the bookmarks corresponding to the entries in the region and associate the bookmarks with the user 210. The selection tools 206 may enable the user 210 to draw the lasso 204 corresponding to the region on the geo-spatial map 200.

The user 210 may select, update and/or modify the entries, and add content to the entries using the selection tools 206. The lasso 204 may be a loop drawn around target location(s) using the selection tools 206. In addition, groups may be created by the user 210 making use of the entries that belong to similar categories in the region corresponding to the lasso 204.

In the example embodiment illustrated in FIG. 2A, the geo-spatial map 200 displays a particular neighborhood in the geo-spatial environment which highlights the markers associated with the locations corresponding to the entries. In addition, the user 210 may create, append and/or delete content associated with the profiles in the lasso group. The user interface view also displays a group name “Apple, Cupertino, Calif., United States” corresponding to the lasso 204.

FIG. 2B is a user interface view of creating a group corresponding to the entries in the neighborhood, according to one embodiment. Particularly, FIG. 2B illustrates the geo-spatial map 200, the lasso 204, the selection tools 206, and a group utility 208, according to one embodiment.

The group utility 208 may enable the user 210 to create groups (e.g., the car lovers group option 312, the classical music group option 314, etc.) corresponding to the entries having similar interests, obtained from the neighborhood in the geo-spatial environment. Further, the group utility 208 may add entries with similar features (e.g., geographic location, interests, demographics, etc.) into a specific group. For example, members 104A-N interested in classical music may be associated with the classical music group option 314.

In the example embodiment illustrated in FIG. 2B, the user interface view displays the geo-spatial map 200, displaying the group name, the neighborhood, and/or lasso 204 drawn on the geo-spatial map 200. For example, the user interface view displays the lasso 204 drawn by the user 210 in a particular region using the selection tools 206. Further, the user interface view also displays the group “Apple, Cupertino, Calif.” created by the user 210 corresponding to the entries obtained from the region associated with the lasso 204 drawn by the user 210.

The members 104A-N residing in the region corresponding to the lasso 204 may be invited to join the group based on the interest, hobbies, profession, etc. On joining the group, the members 104A-N may be able to exchange information pertinent to the group. For example, members 104A-N of a classical music group option 314 may post messages regarding classical music events, instruments, lessons, etc. on a group forum. The members 104A-N of the group may also send private messages to other members in the group. The user interface view also displays the group pointing towards the marker placed adjacent to residence of the user 210, in the example embodiment illustrated in FIG. 2B.

The lasso 204 drawn (e.g., using the selection tools 206 of FIG. 2A-B) on the geo-spatial map 200 by the user 210 may be received. The region may be obtained (e.g., using the member management module 108 of FIG. 1) on the geo-spatial map 200 based on the lasso 204. Further, the entries (e.g., persons, businesses, organizations and/or landmarks) from within the region may be obtained. The group name may be obtained from the user 210. The group may be created (e.g., using the group management module 112 of FIG. 1) under the group name. The entries may be associated with the group.

The bookmarks corresponding to the entries may be created (e.g., using the bookmark management module 110 of FIG. 1). The bookmarks may be associated with the user 210. The user 210 may be enabled to access the entries using the bookmarks. Additional information (e.g., sale, event, neighbor, travel option and/or lodging option) corresponding to the entries may be provided to the user 210. A mass profile edit option associated with the entries may be presented to the user 210 (e.g., the user 210 may edit the profiles of the selected entries simultaneously).

For example, the user 210 may add a group membership to the profiles of the selected entries. The profile analytic associated with the entries may be presented to the user 210. In one example embodiment, the profile analytic corresponds to a statistic related to a profile. For example, the user 210 may be able to view a completeness of a profile, a number of views of the profile, a number of connections with the profile, etc.

FIG. 3 is a user interface view of a homepage of a user (e.g., the user 210 of FIG. 2A-B), according to one embodiment. Particularly, FIG. 3 illustrates a my bookmarks option 300, a my groups option 302, a my places option 304, a my businesses option 306, a my neighbors option 308, a class of 2006 group option 310, a car lovers group option 312, and a classical music group option 314, according to one embodiment.

The my bookmarks option 300 may represent the bookmarks created corresponding to each of the entries in the geo-spatial environment. The my groups option 302 may display the groups created by the user 210 for the entries having similar interests and/or entries associated with similar category. The user 210 may store the entries to a particular group based on the category of each entry, using the information stored in the bookmarks (e.g., the my bookmarks option 300 of FIG. 3).

The my places option 304 may be a bookmark created corresponding to the entries associated with places of interests (e.g., landmarks, historic places, etc.). The my businesses option 306 may be a bookmark created corresponding to the entries associated with the addresses of businesses (e.g., shopping complex, restaurant, organizations, etc.). The my neighbors option 308 may be a bookmark created corresponding to the entries associated with persons residing in the neighborhood of the user 210.

The class of 2006 group option 310 may be a group database containing information associated with the entries of the members 104A-N (e.g., such as co-students of a class in which the user 210 studied in year 2006). The car lovers group option 312 may be a group containing a list of entries who love cars. The classical music group option 314 may contain entries associated with musicians, music shops, music lovers, and/or musical schools.

In the example embodiment illustrated in FIG. 3, the user interface view displays the user 210 homepage containing bookmarks (e.g., the my bookmarks option 300 of FIG. 3) and groups (e.g., the my groups option 302 of FIG. 3). The my bookmarks option 300 may contain the my places option 304, the my businesses option 306, and the my neighbors option 308. Other options and categories may be created under the my bookmarks option 300. The my groups option 302 may contain the class of 2006 group option 310, the car lovers group option 312, and the classical music group option 314.

For example, the entries obtained from the region may be stored in different bookmarks based on the member data associated with each of the entries. The member data may include address data associated with the places, the businesses and/or the persons. The user 210 may view the information associated with the entries.

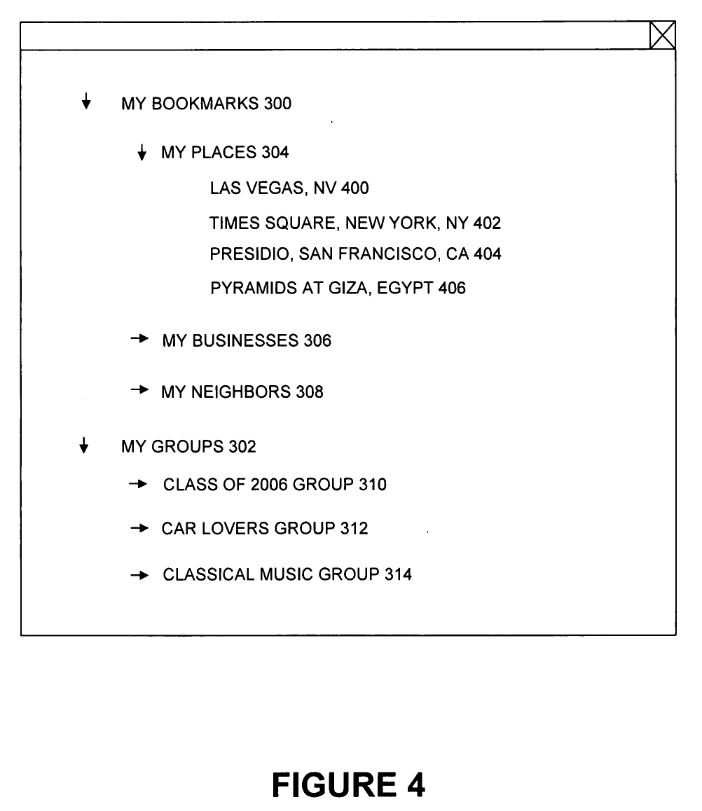

FIG. 4 is a user interface view displaying bookmarks associated with the places, according to one embodiment. The my places option 304 may contain the entries associated with the landmarks and/or the places.

In the example embodiment illustrated in FIG. 4, the user interface view displays name and address data associated with the places and/or the landmarks when the user 210 selects the my places option 304. For example, the my places option 304 displays a landmark “Las Vegas, Nev.” 400, a landmark “Times Square, New York, N.Y.” 402, a landmark “Presidio, San Francisco, Calif.” 404, a landmark “Pyramids at Giza, Egypt” 406.

The user 210 may access each landmark by clicking on the bookmark associated with the landmark. The user 210 may also be shown a geo-spatial map (e.g., the geo-spatial map 200 of FIG. 2A-B) containing the landmark and additional information related to the landmark, such as history, pictures, events, etc. The user 210 may also be shown instant driving directions and/or information of flights to any of the places by clicking on a particular place.

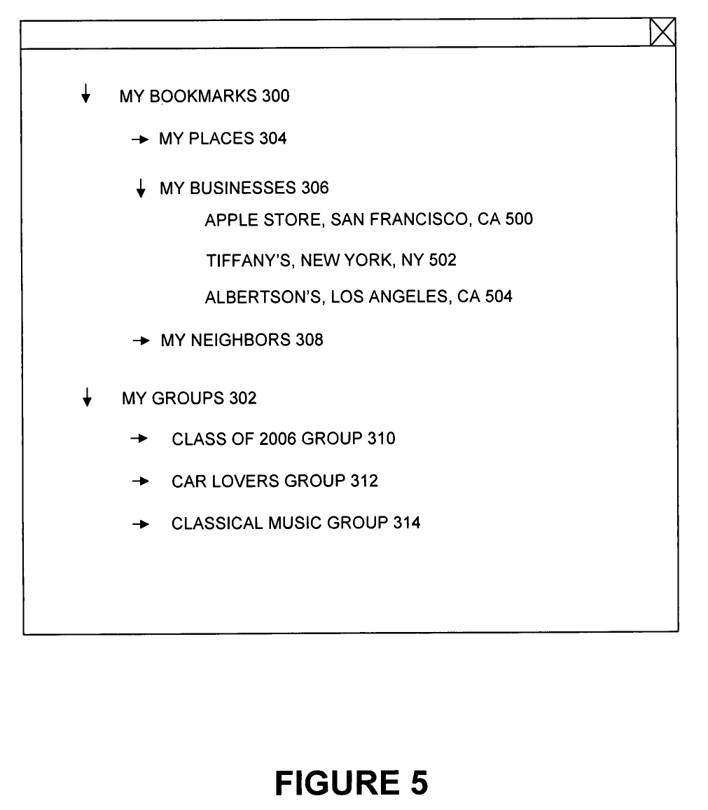

FIG. 5 is a user interface view displaying bookmarks associated with the businesses, according to one embodiment. The my businesses option 306 may contain the list of entries associated with the businesses.

In the example embodiment illustrated in FIG. 5, the user interface view displays name and address of the business when the user 210 selects the my businesses option 306. For example, the my businesses option 306 displays a business “Apple Store, San Francisco, Calif.” 500, a business “Tiffany's, New York, N.Y.” 502, a business “Albertson's, Los Angeles, Calif.” 504. In one example embodiment, each business is associated with a location, as shown in FIG. 5.

The user 210 may store any number of businesses with the same name under the my businesses option 306 and may differentiate among the businesses using the locations of the businesses. The user 210 may also be shown the instant driving directions and/or information of flights to any of the locations associated with the businesses by clicking a particular business link. The user 210 may also view additional information (e.g., type, profile statistics, turnover, opportunities, reviews, ratings, special sales, events, etc.) associated with the businesses.

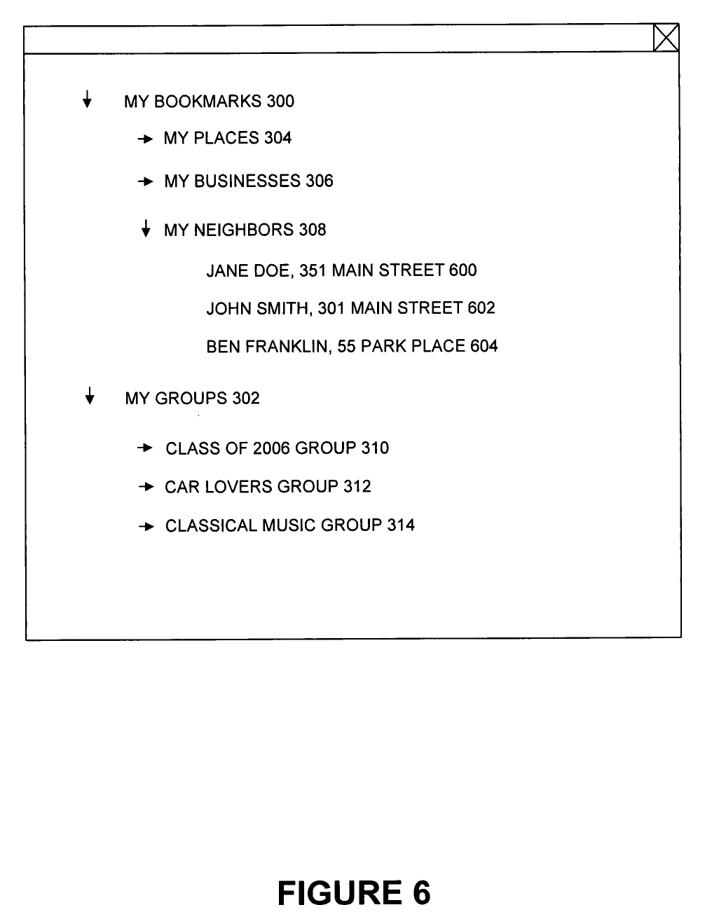

FIG. 6 is a user interface view showing bookmarks associated with the neighbors in a neighborhood, according to one embodiment. The my neighbors option 308 may contain the list of entries associated with the neighbors of the user 210. In the example embodiment illustrated in FIG. 6, the user 210 may reside in a particular neighborhood. In addition, the user 210 may refer to other residents in the neighborhood as neighbors. The neighborhood may be a localized community located in a larger city, town and/or suburb.

In the example embodiment illustrated in FIG. 6, the user interface view displays a name and address of each neighbor under the my neighbors option 308. For example, the my neighbors option 308 displays a neighbor “Jane Doe, 351 Main Street” 600, another neighbor “John Smith, 301 Main Street” 602, and yet another neighbor “Ben Franklin, 55 Park Place” 604. The user interface view may also display additional information associated with the neighbors by selecting a particular neighbor link in the my neighbors option 308. The additional information may include directions to address of the neighbor, a profile of the neighbor, an age of the neighbor, a profession of the neighbor, a marital status of the neighbor, etc.

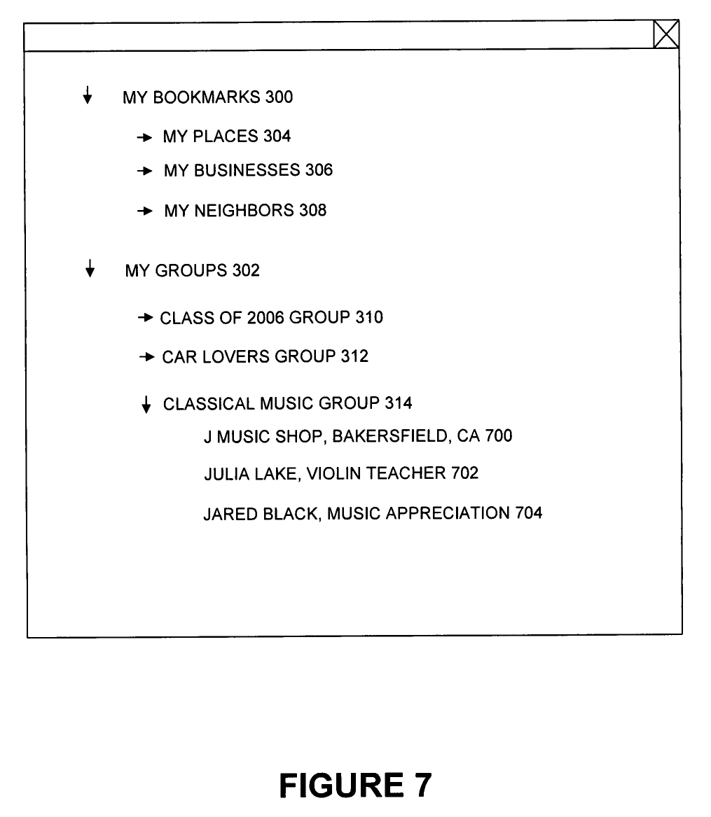

FIG. 7 is a user interface view displaying entries associated with a particular group, according to one embodiment. For example, the classical music group option 314 may contain entries associated with musicians, music lovers, music teachers, music stores, etc. Membership in a group may include people, businesses, and/or organizations. In addition, membership in the group may be private or public. For example, membership in the group may be open to all members of the community network 106, or only some members of the community network 106.

In the example embodiment illustrated in FIG. 7, the user interface view displays the name and address of the entries stored in a particular group when the user 210 selects a particular entry in the group. The classical music group option 314 displays “J Music Shop, Bakersfield, Calif.” 700, “Julia Lake, Violin Teacher” 702, and “Jared Black, Music Appreciation” 704. The user 210 may view information (e.g., type, price, offers, etc.) associated with available instruments in a music shop, and/or profile information of musicians by selecting a particular option from the classical music group option 314.

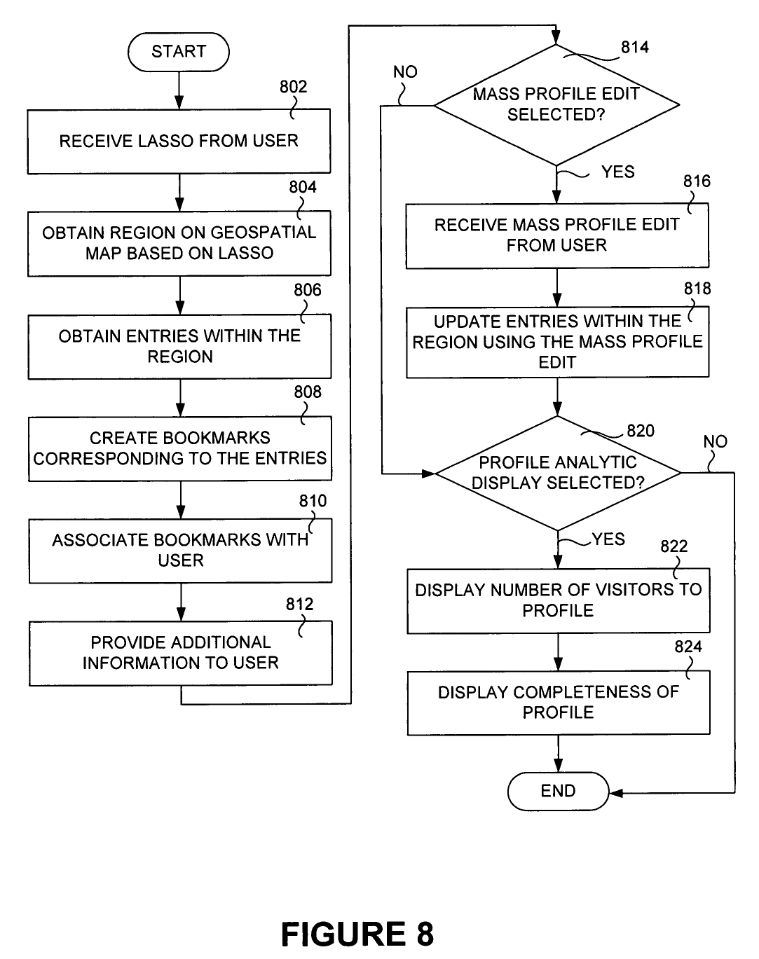

FIG. 8 is a flow chart of geo-spatial bookmark creation, according to one embodiment. In operation 802, a lasso (e.g., the lasso 204 of FIG. 2A-B) from a user (e.g., the user 210 of FIG. 2A-B) is received. For example, the lasso 204 may be drawn by the user 210 on a geo-spatial map (e.g., the geo-spatial map 200 of FIG. 2A-B) using selection tools (e.g., the selection tools 206 of FIG. 2A-B). In operation 804, a region is obtained on the geo-spatial map 200 based on the lasso 204 drawn by the user 210. For example, the region may be represented using one or more latitudes and longitudes forming a polygon. In an alternate embodiment, the region may be represented using a circle with a center and radius. For example, geo-spatial regions may be selected and/or represented using a variety of other methods. In operation 806, the entries are obtained from the members 104A-N located within the region.

In operation 808, bookmarks corresponding to the entries are created. The bookmarks may store information associated with the entries. In operation 810, the bookmarks are associated with the user 210. For example, the bookmarks may be associated with the user's profile and be accessible from a user interface provided to the user 210. In operation 812, additional information corresponding to the entries is provided to the user 210. For example, the additional information may include a sale, an event, a business, a neighbor, a travel option and/or a lodging option. In operation 814, it is determined whether the user 210 has selected a mass profile edit option or not. For example, the user 210 may access and edit a set of entries in bulk using the mass profile edit option. If the user 210 selected the mass profile edit option, then the mass profile edit is received from the user 210 in operation 816.

In operation 818, the entries within the region are updated using the mass profile edit option received from the user 210. If the mass profile edit option is not selected, then operation 820 is performed, in which it is determined whether the user 210 has selected a profile analytic or not. For example, the profile analytic may contain statistics such as the number of people who have edited a profile, content added to a wiki profile, a completeness of a profile, etc. In operation 822, a number of entries previously visited to a profile is displayed as a profile analytic. Other statistics related to the profile may also be displayed to the user 210 as profile analytics. In operation 824, the completeness of the profile is displayed as a profile analytic. For example, the completeness of the profile may represent a percentage of wiki data filled in the profile associated with the entries in the region.

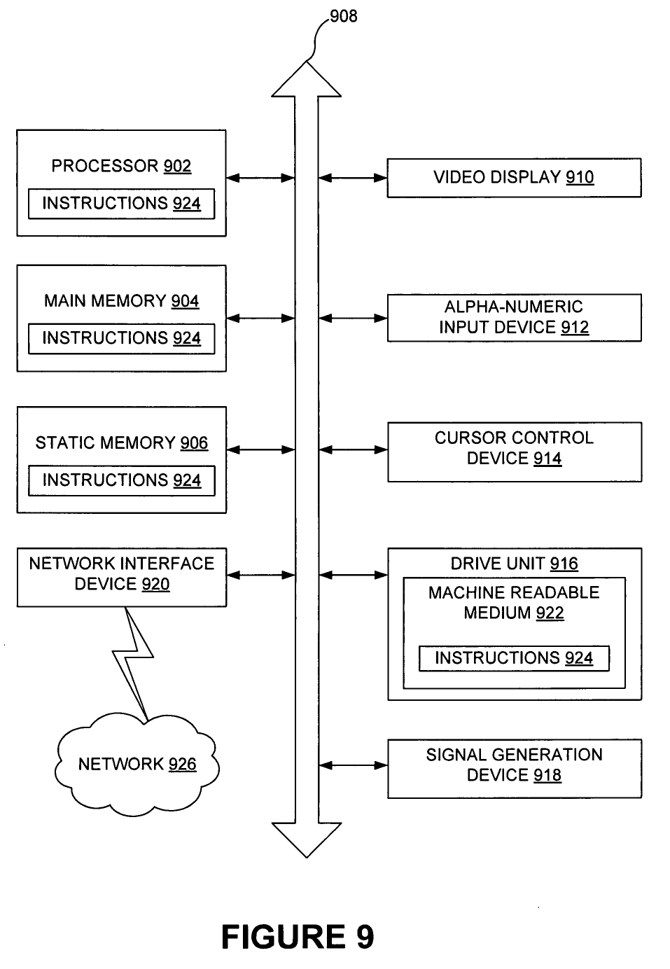

FIG. 9 is a diagrammatic system view 900 of a data processing system in which any of the embodiments disclosed herein may be performed, according to one embodiment. Particularly, the diagrammatic system view 900 of FIG. 9 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924, and a network 926, according to one embodiment.

The diagrammatic system view 900 may indicate a personal computer and/or a data processing system in which one or more operations disclosed herein are performed. The processor 902 may be a microprocessor, a state machine, an application specific integrated circuit, a field programmable gate array, etc. (e.g., Intel® Pentium® processor). The main memory 904 may be a dynamic random access memory and/or a primary memory of a computer system. The static memory 906 may be a hard drive, a flash drive, and/or other memory information associated with the data processing system. The bus 908 may be an interconnection between various circuits and/or structures of the data processing system.

The video display 910 may provide graphical representation of information on the data processing system. The alpha-numeric input device 912 may be a keypad, a keyboard and/or any other input device of text (e.g., special device to aid the physically handicapped). The cursor control device 914 may be a pointing device such as a mouse.

The drive unit 916 may be the hard drive, a storage system, and/or other longer term storage subsystem. The signal generation device 918 may be a bios and/or a functional operating system of the data processing system. The network interface device 920 may be a device that may perform interface functions such as code conversion, protocol conversion and/or buffering required for communication to and from the network 926. The machine readable medium 922 may provide instructions on which any of the methods disclosed herein may be performed. The instructions 924 may provide source code and/or data code to the processor 902 to enable any one/or more operations disclosed herein.

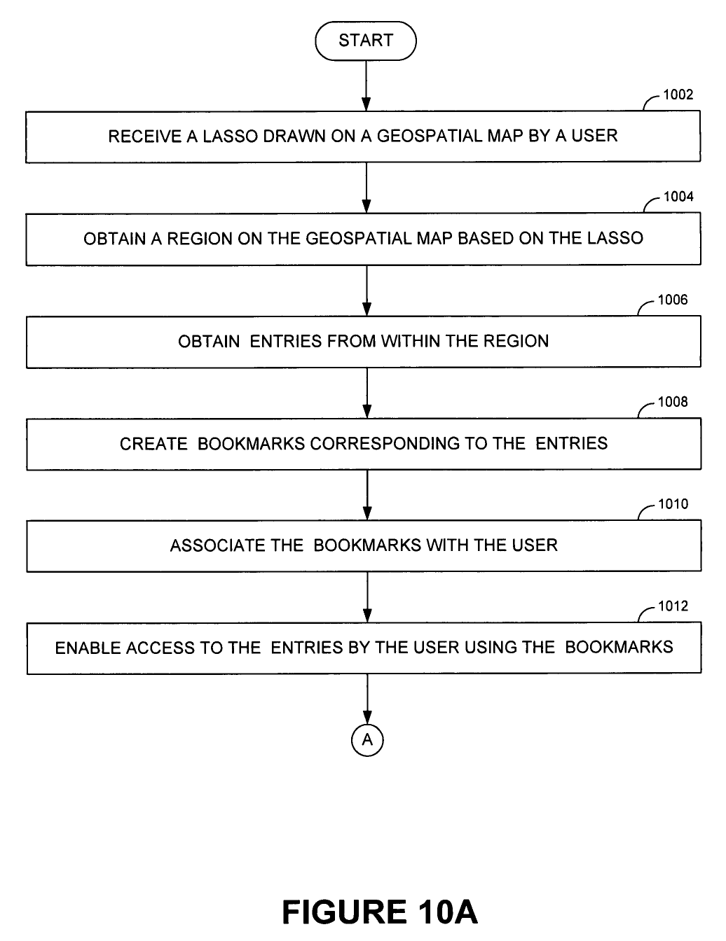

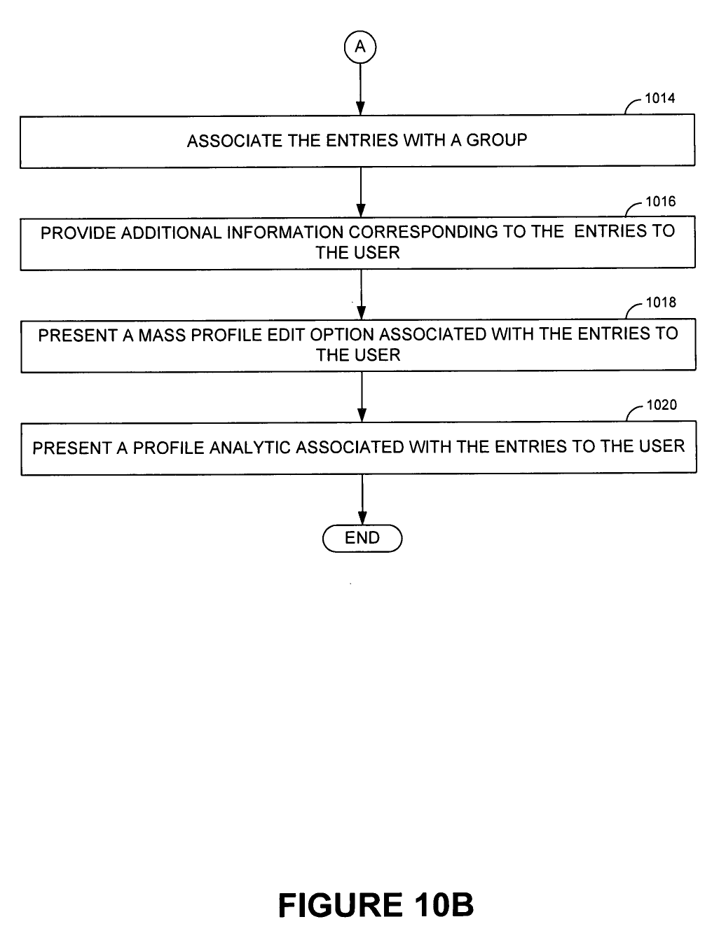

FIG. 10A is a process flow of bookmarking a number of entries, according to one embodiment. In operation 1002, a lasso (e.g., the lasso 204 of FIG. 2A-B) drawn on a geo-spatial map (e.g., the geo-spatial map 200 of FIG. 2A-B) by a user (e.g., the user 210 of FIG. 2A-B) may be received. In operation 1004, a region may be obtained on the geo-spatial map 200 based on the lasso 204. In operation 1006, a number of entries may be obtained (e.g., using the member management module 108 of FIG. 1) from within the region. In operation 1008, bookmarks corresponding to the entries may be created (e.g., using the bookmark management module 110 of FIG. 1). In operation 1010, the bookmarks may be associated with the user 210. In operation 1012, the user 210 may be enabled to access the entries using the bookmarks.

FIG. 10B is a continuation of the process flow of FIG. 10A, showing additional processes, according to one embodiment. In operation 1014, the number of entries may be associated (e.g., using the group management module 112 of FIG. 1) with a group. In operation 1016, additional information corresponding to the entries may be provided to the user 210. In operation 1018, a mass profile edit option associated with the entries may be presented to the user 210. In operation 1020, a profile analytic associated with the entries may be presented to the user 210.

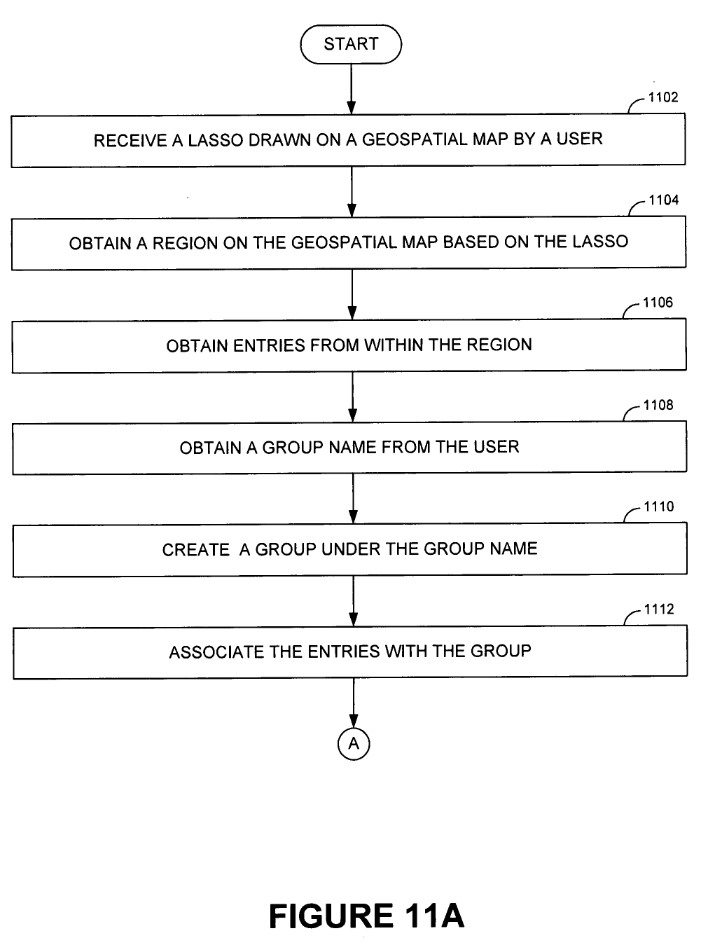

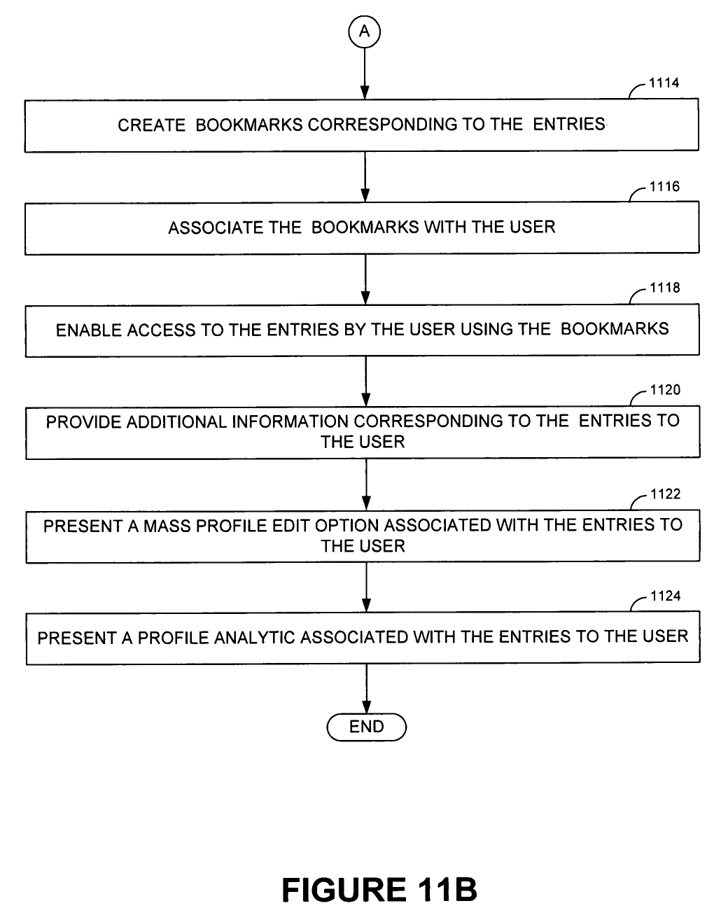

FIG. 11A is a process flow of creating a group in the community network 106, according to one embodiment. In operation 1102, a lasso (e.g., the lasso 204 of FIG. 2A_B) drawn on a geo-spatial map (e.g., the geo-spatial map 200 of FIG. 2A-B) by a user (e.g., the user 210 of FIG. 2A-B) may be received. In operation 1104, a region may be obtained on the geo-spatial map 200 based on the lasso 204. In operation 1106, a number of entries may be obtained (e.g., using the member management module 108 of FIG. 1) from within the region. In operation 1108, a group name may be obtained from the user 210. In operation 1110, a group may be created under the group name. In operation 1112, the number of entries may be associated (e.g., using the group management module 112 of FIG. 1) with the group.

FIG. 11B is a continuation of the process flow of FIG. 11A, showing additional processes, according to one embodiment. In operation 1114, bookmarks corresponding to the entries may be created (e.g., using the bookmark management module 110 of FIG. 1). In operation 1116, the bookmarks may be associated with the user 210. In operation 1118, the user 210 may be enabled to access the entries using the bookmarks. In operation 1120, additional information corresponding to the number of entries may be provided to the user 210. In operation 1122, a mass profile edit option associated with the entries may be presented to the user 210. In operation 1124, a profile analytic associated with the entries may be presented to the user 210.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 108, the bookmark management module 110, the group management module 112, and other modules of FIGS. 1-11 may be enabled using a member management circuit, a bookmark management circuit, a group management circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of bookmarking a plurality of entries, comprising:
receiving a lasso drawn on a geo-spatial map by a user;
obtaining a region on the geo-spatial map based on the lasso;
obtaining the plurality of entries from within the region;
creating a plurality of bookmarks corresponding to the plurality of entries;
associating the plurality of bookmarks with the user; and
enabling access to the plurality of entries by the user using the plurality of bookmarks.

2. The method of claim 1, further comprising associating the plurality of entries with a group.

3. The method of claim 1, further comprising providing additional information corresponding to at least one of the plurality of entries to the user.

4. The method of claim 3, wherein the additional information is at least one selected from a group consisting of a sale, an event, a neighbor, a travel option, and a lodging option.

5. The method of claim 1, further comprising presenting a mass profile edit option associated with the plurality of entries to the user.

6. The method of claim 1, further comprising presenting a profile analytic associated with at least one of the plurality of entries to the user.

7. The method of claim 1, wherein each of the plurality of entries is at least one selected from a group consisting of a person, a business, an organization, and a landmark.

8. A community network, comprising:
a geo-spatial repository comprising a plurality of locations on a geo-spatial map; and
a group management module configured to:
receive a lasso drawn on the geo-spatial map by a user;
obtain a region on the geo-spatial map based on the lasso, wherein the region comprises plurality of entries;
create a group corresponding to the plurality of entries; and
associate the plurality of entries with the group.

9. The community network of claim 8, further comprising:
a bookmark management module configured to:
create a plurality of bookmarks corresponding to the plurality of entries;
associate the plurality of bookmarks with the user; and
enable access to the plurality of entries by the user using the plurality of bookmarks.

10. The community network of claim 8, further comprising:
a member repository comprising a plurality of members, wherein the plurality of members comprises the user; and
a member management module configured to obtain member data associated with each of the plurality of members, wherein the member data comprises one of the plurality of locations.

11. The community network of claim 8, wherein the bookmark management module is further configured to provide additional information corresponding to at least one of the plurality of entries to the user.

12. The community network of claim 11, wherein the additional information is at least one selected from a group consisting of a sale, an event, a neighbor, a travel option, and a lodging option.

13. The community network of claim 8, wherein each of the plurality of entries is at least one selected from a group consisting of a person, a business, an organization, and a landmark.

14. A method of creating a group in a community network, comprising:
receiving a lasso drawn on a geo-spatial map by a user;
obtaining a region on the geo-spatial map based on the lasso;
obtaining a plurality of entries from within the region;
obtaining a group name from the user;
creating a group under the group name; and
associating the plurality of entries with the group.

15. The method of claim 14, further comprising:
creating a plurality of bookmarks corresponding to the plurality of entries;
associating the plurality of bookmarks with the user; and
enabling access to the plurality of entries by the user using the plurality of bookmarks.

16. The method of claim 14, further comprising providing additional information corresponding to at least one of the plurality of entries to the user.

17. The method of claim 16, wherein the additional information is at least one selected from a group consisting of a sale, an event, a neighbor, a travel option, and a lodging option.

18. The method of claim 14, further comprising presenting a mass profile edit option associated with the plurality of entries to the user.

19. The method of claim 14, further comprising presenting a profile analytic associated with at least one of the plurality of entries to the user.

20. The method of claim 14, wherein each of the plurality of entries is at least one selected from a group consisting of a person, a business, an organization, and a landmark.
